(19) United States
(12) Patent Application Publication
(10) Pub. No.: US 2025/0240291 A1
(43) Pub. Date: Jul. 24, 2025

(54) SECURE IDENTIFICATION OF AIR-GAPPED NETWORKS USING ONE-WAY COMMUNICATION

(71) Applicant: SHEBA IMPACT LTD., Ramat-Gan (IL)

(72) Inventors: Lavi FRIEDMAN, Hertzelia (IL); Edo SHILOH, Timrat (IL); Shay SHEMESH, Ramla (IL); Eyal INBAR, Beer Yaakov (IL)

(73) Assignee: SHEBA IMPACT LTD., Ramat-Gan (IL)

(21) Appl. No.: 18/702,128

(22) PCT Filed: Oct. 13, 2022
(86) PCT No.: PCT/IL2022/051089

§ 371 Date: Apr. 17, 2024

Related U.S. Application Data
(60) Provisional application No. 63/256,581, filed on Oct. 17, 2021.

(51) Int. Cl. H04L 9/40

(52) U.S. Cl. CPC H04L 63/0876

(57) ABSTRACT

Disclosed herein are receive-only network devices and methods for use for securely identifying a network. The receive-only network device comprised a network physical layer (PHY) circuit configured to establish a physical layer connection to a network via one or more wired transmission mediums and a controller electrically coupled to a receive channel of the PHY via a unidirectional hardware buffer configured to transfer electronic signals received from the PHY and block electronic signals received from the controller. The controller is configured to receive from the PHY one or more link layer frames transmitted by one or more network controllers of the network and intercepted by the PHY, extract one or more network attributes of the network from the one or more intercepted link layer frames, identify the network at least partially according to the one or more extracted network attributes, and present the identity of the network to a user.

### RELATED APPLICATION/S

This application claims the benefit of priority of U.S. Provisional Patent Application No. 63/256,581 filed on Oct. 17, 2021, the contents of which are incorporated herein by reference in their entirety.

### FIELD AND BACKGROUND OF THE INVENTION

The present invention, in some embodiments thereof, relates to securely identifying a network and its operational attributes, and, more specifically, but not exclusively, to securely identifying a network and its operational attributes using a receive-only network device incapable of transmitting data via the network.

Network infrastructures connecting network nodes, devices, systems, platforms, and/or services are the corner stone of practically any computerized environment in modern day life.

Most of these network environments may be open networks in which connections are not closely monitored. However, some high security networking environments, for example, defense systems, financial systems, private data storage and/or the like which may provide access to confidential, secret, private and/or sensitive information may use highly secure networks.

The secure networks may be constantly monitored to check and verify each connection to the network. Moreover, in many cases in order to further increase their safety and security, the secure networks may be completely isolated networks, also referred to as air-gapped networks, which are deployed and configured to connect only authorized network nodes while disconnected from any other external networks.

### SUMMARY OF THE INVENTION

It is an object of the present invention to provide, methods, systems and software program products for securely probing networks using a receive-only network device configured to probe the networks without exposing the networks to potential malicious attacks. The foregoing and other objects are achieved by the features of the independent claims. Further implementation forms are apparent from the dependent claims, the description and the figures.

According to a first aspect of the present invention there is provided a receive-only network device for securely identifying a network, comprising a network physical layer (PHY) circuit configured to establish a physical layer connection to a network via one or more wired transmission mediums, and a controller electrically coupled to a receive channel of the PHY via a unidirectional hardware buffer configured to transfer electronic signals received from the PHY and block electronic signals received from the controller. The controller is configured to:
Receive from the PHY one or more link layer frames transmitted by one or more network controllers of the network and intercepted by the PHY.
Extract one or more network attributes of the network from the one or more intercepted link layer frames.
Identify the network at least partially according to the one or more extracted network attributes.
Present the identity of the network to a user.

According to a second aspect of the present invention there is provided a method of securely identifying a network using a receive-only network device, comprising using a controller of a receive-only network device comprising a network physical layer (PHY) circuit configured to establish a physical layer connection to a network via one or more wired transmission medium.

The controller is used for:
Receiving from the PHY one or more link layer frames transmitted by one or more network controllers of the network and intercepted by the PHY.
Extracting one or more network attributes of the network from the one or more intercepted link layer frames.
Identifying the network at least partially according to the one or more extracted network attributes.
Presenting the identity of the network to a user;

In a further implementation form of the first and/or second aspects, a transmit channel of the PHY is physically disconnected.

In an optional implementation form of the first and/or second aspects, a second hardware buffer connecting the receive channel of the PHY to the controller, the second hardware buffer is configured to transfer electronic signals received from the PHY and block electronic signals received from the controller.

In a further implementation form of the first and/or second aspects, the second hardware buffer comprises a hardware programmable logic circuit configured to have an input only port connected to the PHY and an output only port connected to the controller.

In an optional implementation form of the first and/or second aspects, another unidirectional hardware buffer configured to transfer electronic signals from the hardware programmable logic circuit to the controller and block signals received from the controller.

In a further implementation form of the first and/or second aspects, the one or more wired transmission mediums are members of a group consisting of: a copper cable and an optical fiber.

In a further implementation form of the first and/or second aspects, the PHY is further configured to disable auto-negotiation sequence via the one or more wired transmission mediums and apply half-duplex 10Base-T using normal link pulses (NLP) protocol to connect to the network.

In a further implementation form of the first and/or second aspects, the link layer frame is defined by one or more station and media access control connectivity discovery protocols.

In a further implementation form of the first and/or second aspects, the one or more network attributes comprises one or more members of a group consisting of: a type of the one or more network controllers, a name of the one or more network controllers, a media access controller (MAC) address of the one or more network controllers, an internet protocol (IP) address of the one or more network controllers, a management port of the one or more network controllers, a port number of the one or more network controllers connected to the receive-only network device, a power over Ethernet (POE) capability, a network time protocol (NTP) capability, a hierarchy of the one or more network controllers, a structure of the network, an IP address range of at least a segment of the network, a network name of the network, a domain name of the networks, one or more virtual local area network (VLAN) domains in the network, and one or more cisco discovery protocol (CDP) parameters announced by the one or more network controllers.

In an optional implementation form of the first and/or second aspects, the controller is further configured to compare between one or more of the extracted network attributes and a corresponding one or more reference network attributes logged in one or more network information record stored in the receive-only network device.

In a further implementation form of the first and/or second aspects, the controller is configured to output a discrepancy indication in case of no-match between one or more of the extracted network attributes and the corresponding one or more reference network attributes.

In a further implementation form of the first and/or second aspects, the controller is configured to output an approval indication in case of a match between one or more of the extracted network attributes and the corresponding one or more reference network attributes.

In an optional implementation form of the first and/or second aspects, the controller is configured to present additional network information for the network in case of a match between one or more of the extracted network attribute and the corresponding one or more reference network attribute, the additional network information is stored in the one or more network information records.

In a further implementation form of the first and/or second aspects, the controller is further configured to update the one or more network information records according to one or more network information update frames transmitted by a dedicated server and intercepted by the PHY from the network.

In an optional implementation form of the first and/or second aspects, the one or more network information update frames are signed with a signature used by the controller to verify the one or more network information update frames.

In a further implementation form of the first and/or second aspects, the identity of the network is presented to a user via a screen of the receive-only network device.

In an optional implementation form of the first and/or second aspects, the controller is configured to present the network identity via the screen according to one or more user interface (UI) rules defined by a one or more UI configuration records stored in the receive-only network device.

In an optional implementation form of the first and/or second aspects, the controller is configured to update the one or more UI configuration records according to one or more UI update frames transmitted by a dedicated server and intercepted by the PHY from the network.

In an optional implementation form of the first and/or second aspects, the one or more UI update frames are signed with a signature used by the controller to verify the one or more UI update frames.

In an optional implementation form of the first and/or second aspects, the controller is configured to discard the one or more network attributes and the network identity extracted from the one or more intercepted link layer frames.

In an optional implementation form of the first and/or second aspects, the controller is configured to update code executed by the controller according to one or more code version update (CVU) frames transmitted by a dedicated server and intercepted by the PHY from the network.

In an optional implementation form of the first and/or second aspects, the one or more CVU frames is signed with a signature used by the controller to verify the one or more CVU frames.

In an optional implementation form of the first and/or second aspects, the receive-only network device comprises one or more hardware programmable logic circuits configured to electrically drive one or more input only control signals of the PHY in order to operate the PHY to conduct time-domain reflection (TDR) testing and/or optical time-domain reflection (OTDR) for testing integrity of a hardware infrastructure of the network according to reflections of signals transmitted by the PHY to the network.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, 10 will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A and FIG. 1B present a flowchart of an exemplary process of identifying a network and its operational attributes using a receive-only network device, according to some embodiments of the present invention; and

FIG. 2A and FIG. 2B are schematic illustrations of an exemplary system for identifying a network and its operational attributes using a receive-only network device, according to some embodiments of the present invention.

### DESCRIPTION OF SPECIFIC EMBODIMENTS OF THE INVENTION

The present invention, in some embodiments thereof, relates to securely identifying a network and its operational attributes, and, more specifically, but not exclusively, to securely identifying a network and its operational attributes using a receive-only network device incapable of transmitting data via the network.

Connecting to networks in order to identify them and explore their structure, domains, capabilities, services, and/or the like may be applied for one or more uses and applications, for example, network maintenance, network failure troubleshooting, and/or the like. However, such network identification and exploration may be essential to support efficient, robust and/or extensive scrutinization of the network in order to detect potential security breaches, for example, connected unauthorized network nodes, potentially compromised network controllers, altered network parameters and/or the like.

Identifying and exploring networks may be done using network probing equipment which communicates, using two-way transmit/receive communication, with other network nodes of the network in order to probe the network and gather the network information. However, while this approach may be efficient for open networks, connecting such two-way network probing equipment to highly secure networks, for example, isolated (air-gapped) networks may present major risks and threats to the network and its connected nodes since such a two-way connection may expose the secure network to malicious and hostile cyberattacks, malware and/or the like originating from the connected two-way network probing equipment.

According to some embodiments of the present invention, there are provided methods, systems, devices and computer software programs for exploring network in order to identify the network and its network attributes using a receive-only network device which may connect to the network but is physically incapable of transmitting data, i.e., data frames via the network.

The receive-only network device may comprise a network Physical Layer (PHY) configured to physically connect to the explored network, specifically to a network controller of the network, for example, a switch, a router, a gateway, a bridge, a multiplexer, a transceiver, a firewall and/or the like via one or more wired transmission mediums, for example, copper wires, optical fibers and/or the like. In some scenarios and/or deployments the network controller may further include one or more network nodes, for example, a computer, a server and/or the like.

The PHY configured to establish a physical layer connection with the network controller may provide one or more physical layer functionalities, service and/or capabilities as known in the art, for example, bit-by-bit or symbol-by-symbol data delivery over the physical transmission medium, electromagnetic compatibility (spectrum frequency allocation, signal strength, analog bandwidth, etc.), line coding for converting data into a pattern of electrical fluctuations which may be modulated onto a carrier wave or infrared light, bit synchronization, start-stop signaling, flow control and/or the like.

However, the receive-only network device may be configured for receive-only operation and interaction with the network by specifically configuring its PHY to physically disable its transmit (output) channel. The PHY comprising one or more circuits, components, devices and/or the like is deployed and connected to the network on one end and to a local network controller on the other hand such that, while able to establish a physical layer connection with the network, it is unable to transmit frames (packets) via the network.

The receive-only network device may be therefore capable of receiving and intercepting (data) frames transmitted via the network by other network nodes but is unable to transmit frames to the network and thus unable to inject data to the network.

Several mechanisms are applied to physically disable the PHY from transmitting frames to the network. First, the transit channel of the PHY, which is typically connected to the local network controller, for example, a Media Access Controller (MAC) and used by the local network controller to send data to the PHY for transmittal to the network, is physically disconnected and left open, optionally with some electrical termination to prevent them from floating.

Moreover, the receive channel of the PHY, used by the PHY to transmit data to the local network controller data received from the network (and optionally status data generated by the PHY), may be routed through a unidirectional hardware buffer implemented using one or more hardware elements which is unmodifiable and thus cannot be tampered. Data may therefore flow via the buffered receive channel only from the PHY to the local network controller and not in the other direction.

Optionally, a second unidirectional hardware buffer may be deployed to buffer the receive channel to further ensure that data may therefore flow via the buffered receive channel only from the PHY to the local network controller and not in the other direction. The second unidirectional hardware buffer may be implemented using one or more logic circuits, components, programmable devices, specifically tamper proof programmable devices and/or a combination therefore.

Optionally, the PHY may be configured to disable an auto-negotiation sequence typically initiated with the network controller of the network via the wired transmission medium. In such case, as defined by the physical layer protocol, the physical connection of the PHY with the network controller via the wired transmission medium may drop to the basic transmission parameters, for example, half-duplex 10Base-T. The auto-negotiation functionality may be configurable manually via one or more configuration provisions and/or in response to instructions from a controller of the receive-only network device.

After physically connected to the network, the PHY may intercept a plurality of frames transmitted via the network by one or more of the other network nodes connected to the network, for example, a computer, a server, a network controller and/or the like. The PHY may transfer the intercepted frames to the local network controller via the buffered receive channel.

The local network controller may then forward the intercepted frames to the controller (or processor) of the receive-only network device which may analyze the received frames and extract and/or derive network attributes of the network in order to identify the network and other network information relating to the network, for example, network equipment, network controller, network structure, domains, segments, capabilities, services, and/or the like.

The network attributes may include, for example, type of the network controller(s) of the network, name of the network controller(s), MAC address of the network controller(s), Internet Protocol (IP) address of the network controller(s), management port(s) of the network controller(s), port number of the network controller(s) connected to the receive-only network device, Power over Ethernet (POE) capability, Network Time Protocol (NTP) capability, hierarchy (level) of the network controller, structure of the network, IP address range of one or more segments of the network, network name, domain name of the network, one or more Virtual Local Area Network (VLAN) domains in the network, one or more CDP parameters announced by the network controller(s) and/or the like.

The controller may be capable of receiving and analyzing frames transmitted via the network according to a plurality of protocols residing in a plurality of layers of the network model, for example, data link layer (L2), network layer (L3), transport layer (L4), session layer (L5), presentation layer (L6) and/or application layer (L7).

However, while capable of deriving one or more of the network attributes of the explored network from frames of higher protocols, the controller may focus on analyzing link layer frames intercepted by the PHY since the link layer frames may contain data which is highly indicative and useful to extract and/or derive the network attributes. The link layer frames may be defined by one or more link layer protocols according to IEEE 802.1AB with additional support in IEEE 802.3 section 6 clause 79, for example, Link Layer Discovery Protocol (LLDP), Cisco Discovery Protocol (CDP), Foundry Discovery Protocol, Nortel Discovery Protocol, Link Layer Topology Discovery, Address Resolution Protocol (ARP), Reverse Address Resolution Protocol (RARP), Neighbor Discovery Protocol (NDP) and/or the like.

The controller may further operate a screen of the receive-only network device to present to one or more users the network identity, network information and/or the network attributes extracted and/or derived from the analyzed frames.

Optionally, the controller may compare between the network information extracted from the intercepted frames and reference network information relating to the explored network which is locally stored in the receive-only network device in one or more network information records, for example, a file, a list, a table, a data structure and/or the like. Moreover, the controller may initiate one or more indications and/or alert to indicate the user(s) of compliance and/or discrepancy(s) detected in the extracted network information compared to the reference network information.

Optionally, the controller may update the network information record(s) according to one or more update frames transmitted by a dedicated server via the network and intercepted by the PHY which contain an update package to the network information record(s).

Optionally, the controller may operate the screen of the receive-only network device to present network information relating to the explored network according to one or more User Interface (UI) configuration rules defined by one or more UI configuration record(s) locally stored at the receive-only network device.

Optionally, the controller may update the UI configuration record(s) according to one or more update frames transmitted by the dedicated server via the network which contain an update package to the UI configuration record(s).

Optionally, the controller may update one or more code segments (e.g. firmware, software, etc.) executed by the controller from a local storage of the receive-only network device according to one or more update frames transmitted by the dedicated server via the network which contain an update package to the code segment(s).

Optionally, the dedicated server signs one or more of the update frames with a unique signature in order to enable the receive-only network device to verify that the update frames originate from the dedicated server.

Optionally, after presenting the network information to the user and/or a predefined time after disconnecting from the network, the controller may discard the network information exacted from the intercepted frames.

Using the receive-only network device to explore the network and collect its network attributes may present major advantages and benefits compared to existing network exploration methods, apparatuses and systems.

First, since the receive-only network device is unable to transmit frames to the network it is connected to, the receive-only network device may not inject data to the network as may be done by the exiting methods. The existing methods using network probing equipment which establishes a two-way communication with the one or more network nodes and/or network controllers of the network may therefore expose the network and its nodes to one or more risks, threats, cyberattacks and/or exploitations originating from the connected two-way network probing equipment. The receive-only network device, on the other hand, which is incapable of injecting data to the network may securely explore the network while ensuring its safety and isolation.

Moreover, disabling the auto-negotiation sequence typically initiated upon connection to the network, which may include transmittal of at least some frames from the receive-only network device, may further reduce the signature left by the receive-only network device in the network.

Furthermore, since the receive-only network device is incapable of transmitting data, the network information, i.e., the network attributes collected from the network, which may include sensitive data and/or data which may be used to compromise the network (nodes), may not be retrieved from the receive-only network device. Moreover, discarding the extracted network information after presented to the user(s) may further ensure that the extracted network information may not be seized by malicious parities and used in attempt to compromise the network.

In addition, comparing between the network information extracted from the frames transmitted via the explored network and reference network information of the explored network may reveal changes, inconsistencies, discrepancies and/or incompatibilities which may be indicative of potential malicious intervention and/or presence in the network, its network controller(s) and/or network nodes. Comparing the extracted network information with the reference network information may further reveal one or more configuration errors and/or discrepancies in one or more settings of the network controller which impact network behavior, for example, mapping, routing, performance and/or the like.

Also, presenting the network information relating to the explode network according to the UI configuration rules may enable the user(s) to customize and/or adjust the displayed data and/or its format according to his needs and/or preferences.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

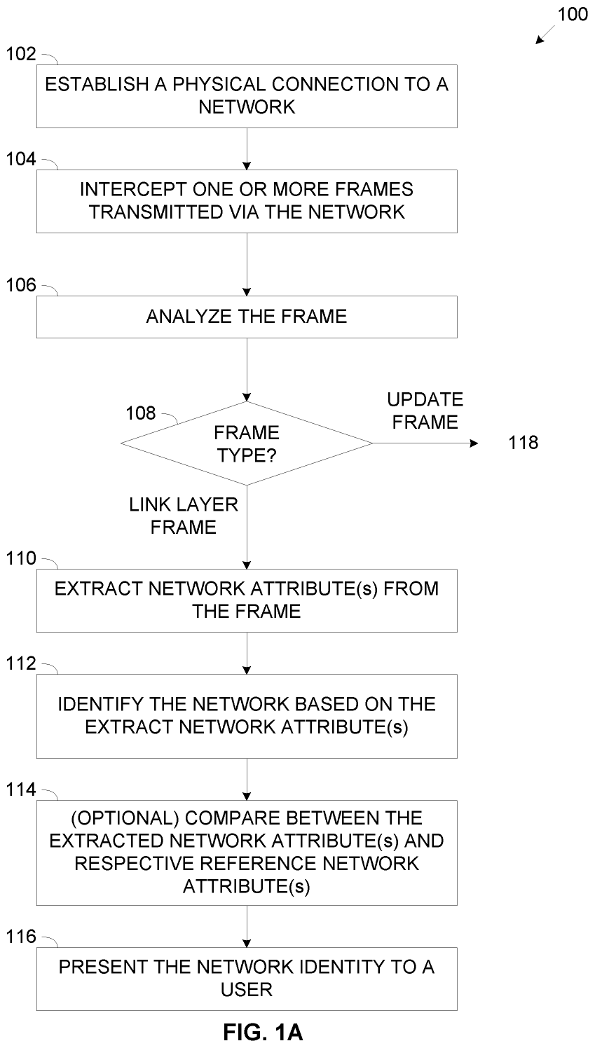

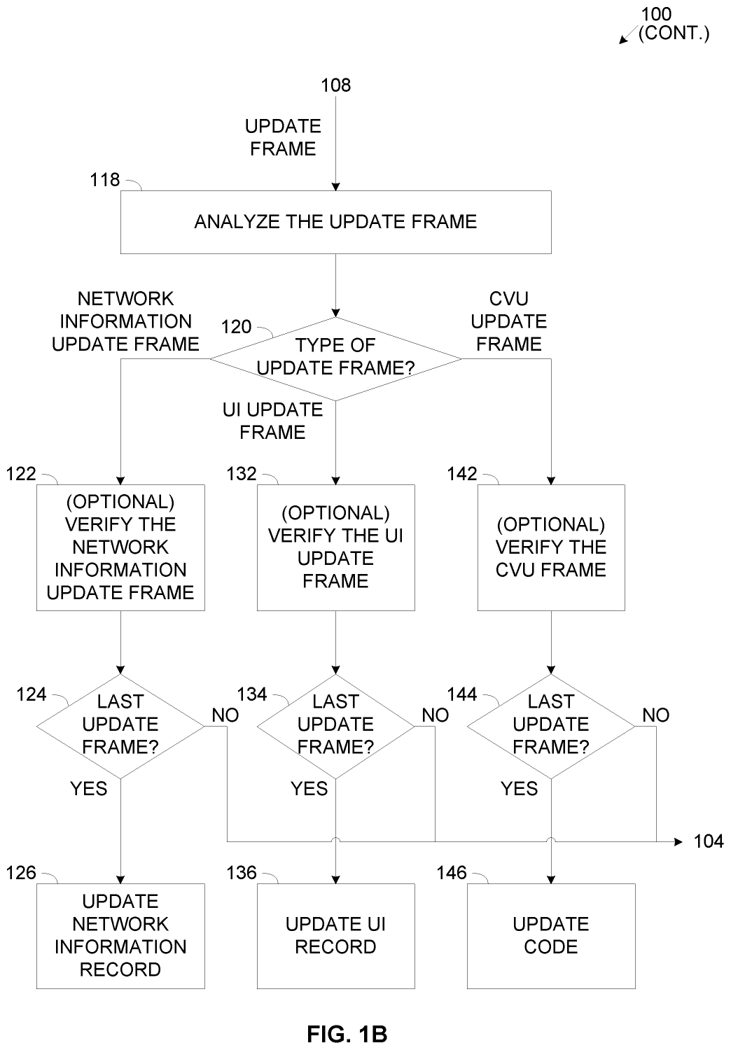

Referring now to the figures, FIG. 1A and FIG. 1B, present a flowchart of an exemplary process of identifying a network and its operational attributes using a receive-only network device, according to some embodiments of the present invention.

An exemplary process 100 may be executed by network device, specifically a receive-only network device which may connect to one or more networks. The receive-only network device may be configured for receive-only operation and interaction with the network by connecting to the network via a network Physical Layer (PHY) comprising one or more circuits, components, devices and/or the like which is physically deployed and connected such that it is able to establish a physical layer connection with the network while unable to transmit frames (packets) via the network.

As such, while able to receive and intercept frames transmitted via the network by other network nodes, the receive-only network device may be unable to transmit frames to the network.

Since it is able to receive frames transmitted via the network, the receive-only network device may intercept at least some of the frames, specifically link layer frames, extract one or more network attributes from the intercepted frame(s) and identify the network and/or its attribute(s) accordingly.

However, as it is unable to transmit frames via the network, the receive-only network device may be unable to inject data to the network thus preventing the receive-only network device from initiating potential malicious and/or hostile cyberattacks in attempt to compromise the other network nodes.

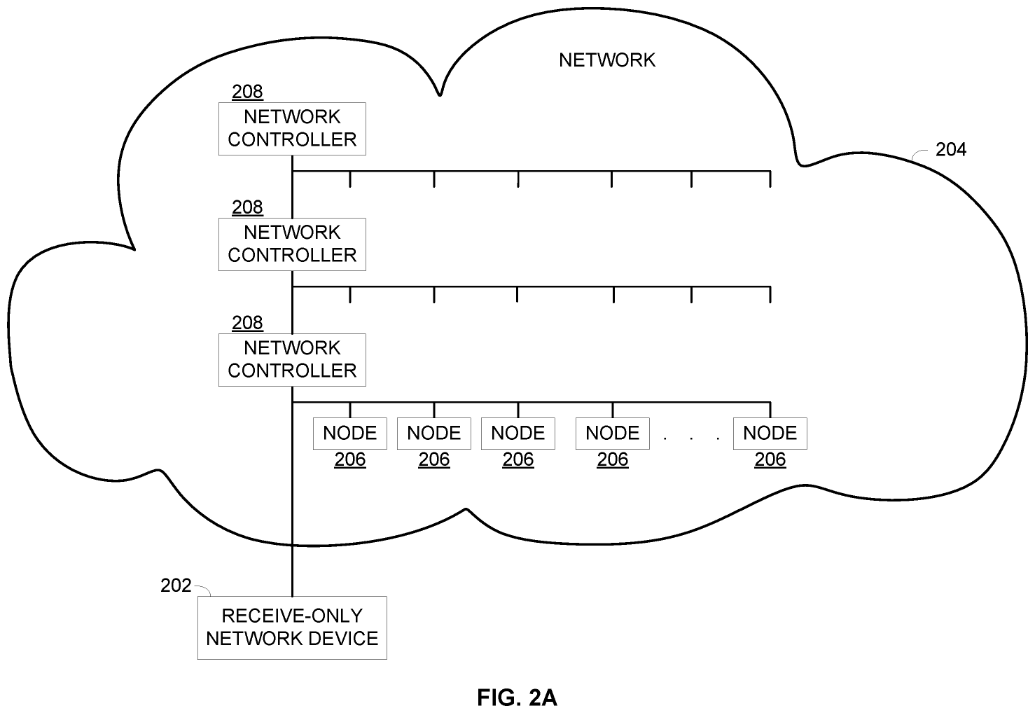

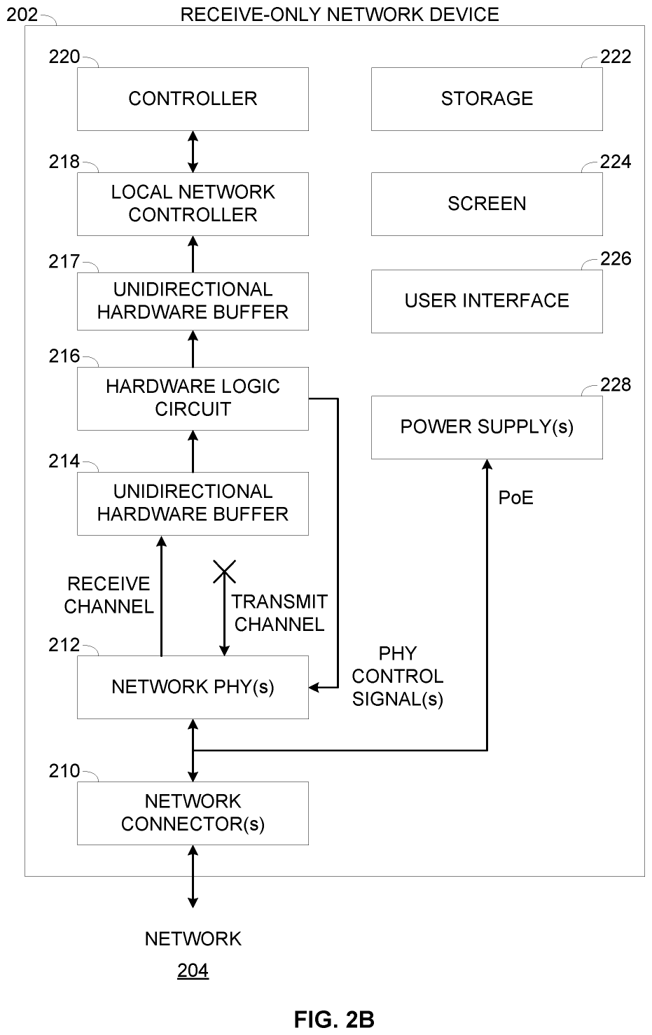

Reference is also made to FIG. 2A and FIG. 2B, which are schematic illustrations of an exemplary system for identifying a network and its operational attributes using a receive-only network device, according to some embodiments of the present invention.

As seen in FIG. 2A, a receive-only network device 202 may connect to an exemplary network 204 comprising one or more networks, for example, a Local Area Network (LAN), a Wide Area Network (WAN) and/or the like connecting a plurality of network nodes 206, for example, a computer, a server, a processing node, a cluster of processing nodes and/or the like.

The network 204 may include one or more network controllers (network equipment) 208 as known in the art, for example, a switch, a router, a gateway, a bridge, a multiplexer, a transceiver, a firewall and/or the like deployed to from and support he network 204 by hosting and connecting to the plurality of network nodes 206. In some scenarios and/or deployments the network controllers 208 may further include one or more network nodes such as the network nodes 206.

The network controller(s) 208 may be deployed, configured and/or adapted to facilitate the network 204 according to one or more topologies, as known in the art, for example, star and/or mesh switched connection, token ring, bus and/or the like. For example, the most widely used networks are based on IEEE 802.3 (Ethernet) protocols employing switched connection and each network controller 208 may be therefore configured to have a plurality of point-to-point ports each for connecting to a respective network node 208 and/or another network controller 208.

Moreover, the network controller(s) 208 may be deployed, configured and/or adapted to form the network 204 according to one or more structures, deployments and/or configurations as known in the art, for example, a flat network, a hierarchical network comprising a plurality of levels (layers), a segmented network comprising a plurality of segments and/or the like.

It should be noted again that the network 204 illustrated in FIG. 2A is exemplary and should not be construed as limiting since the network 204 may employ a plurality of other deployments and arrangements as may become apparent to a person skilled in the art.

Moreover, the network 204 may be an isolated (air-gapped) network connecting a plurality of network nodes 206 in a secure manner. Access to the network 204 may be therefore limited and subject to strict security procedures and measures in order to ensure that no potential malicious and/or compromised network devices and/or equipment may connect to the network 204 in attempt to compromise the network resources connected to the network 204, specifically, the network nodes 206 and/or the network controller(s) 208.

As the network 204 is isolated and air-gapped in order to maintain high security, the network 204 may typically not connect to wireless networks and may rather compromise only wired networks which may employ one or more transmission mediums, for example, a copper wire, an optical fiber and/or the like.

As seen in FIG. 2B, the receive-only network device 202 may comprise a network connector(s) 210, a network PHY 212, a unidirectional hardware buffer 214, an optional hardware programmable logic circuit 216, a local network controller 218, a controller 220 for executing the process 100 and a storage 222 for storing data and/or code (program store).

While it may be a large and mostly stationary device, the receive-only network device 202 may typically be a light-weight mobile device which may easily carried by one or more users who may travel between facilities, locations and sites in networks such as the network 204, specifically isolated networks are deployed. As such, the users may use the light-weight mobile receive-only network device 202 to identify a plurality of different isolated networks deployed as distinct locations and/or one or more of their network attributes.

The network connector(s) 210 may include one or more network connectors as known in the art configured to receive and accommodate one or more mating connectors, plugs, receptacles and/or the like one or more cables, optical fiber lines and/or the like connected to the network 204, in particular to one of the network controller(s) 208. For example, the network connector(s) 210 may include one or more copper wire cable connectors, for example, an RJ45 jack and/or the like configured to receive and accommodate one or more copper wire cables equipped with mating plugs. In another example, the network connector(s) 210 may include one or more optical fiber network interface transceiver modules configured to receive and accommodate one or more optical fiber cables, for example, a Small Form-factor Pluggable (SFP), a Quad Small Form-factor Pluggable (QSFP) and/or the like.

The network PHY 212 connected to the network connectors(s) 210 may include one or more network PHYs configured to establish a physical layer connection with the network 204, specifically with one of the network controller(s) 208 and facilitate physical layer functions of the OSI model.

The PHY 212 implemented using one or more circuits, components, Integrated Circuits (IC), Application Specific Integrated Circuits (ASIC) and/or the like may connect to a link layer device such as the local network controller 218, for example, a Media Access Controller (MAC) and/or the like in order to enable data transfer from connect the physical transmission medium of the network 204, for example, the copper wire, the optical fiber and/or the like to the local network controller 218.

The PHY 212 may provide a plurality of functions and services as known in the art, for example, bit-by-bit or symbol-by-symbol data delivery over the physical transmission medium, electromagnetic compatibility (spectrum frequency allocation, signal strength, analog bandwidth, etc.), line coding for converting data into a pattern of electrical fluctuations which may be modulated onto a carrier wave or infrared light, bit synchronization, start-stop signaling, flow control and/or the like.

The PHY 212 may be therefore configured and adapted as known in the art to connect, via the connector(s) 210, to one or more of the transmission mediums applicable in the network 204 according to the topology of the network 204. For example, the PHY 212 may be configured to connect to a star topology switched connection Ethernet network utilizing a two-pair copper wires cable, a four-pair copper wires cable and/or the like. In another example, the PHY 212 may connect to one or more optical fiber cables. In such case, the PHY 212 may be optionally integrated with the connector(s) 210, specifically in the optical fiber network interface transceiver module(s).

The PHY 212 may include one or more channels through which PHYs such as the PHY 212 are typically connected to respective network controllers such as the local network controller 218. In particular, the PHY 212 may include separate receive and transmit channels. For example, the PHY 212 may include a receive channel through which the local network controller 218 may receive (read) from the PHY 212 data intercepted and received from the network 204. The PHY 212 may also include a transmit channel through which the local network controller 218 may transmit (write) to the PHY 212 data to be transmitted via the network 204.

The receive and transmit channels connecting the PHY 212 and the local network controller 218 may be implemented using one or more interfaces, interconnections and/or links as known in the art, for example, Media-Independent Interface (MII), Reduced MII (RMII), Gigabit MII (GMII), Reduced GMII (RGMII), Serial GMII (SGMII) and/or the like.

However, in order to ensure that the receive-only network device 202 is incapable of injecting data into the network 204 by transmitting frames via the network 204, the transmit channel of the PHY 212 may be physically disconnected from any other device, in particular from the local network controller 218 and from the controller 220. Specifically, the transmit channel may be left open and unconnected, optionally with some electrical termination components to prevent the transmit channel signal(s) from floating. The PHY 212 may be therefore unable to receive data for transmittal via the network 204 thus ensuring that no frames may be transmitted from the receive-only network device 202 via the network 204.

Moreover, the receive channel used by the PHY 212 to transmit data to the local network controller 218 is routed through a unidirectional hardware buffer 214 implemented using one or more hardware elements, for example, a circuit, an IC and/or the like which due to its unmodifiable hardware nature may not be tampered. This means that data may flow via the unidirectional hardware buffer 214 buffering the receive channel only from the PHY 212 to the local network controller 218. Data flow from the local network controller 218 to the PHY 212 is via the unidirectional hardware buffer 214 buffering the receive channel is therefore impossible even if the receive channel was somehow hacked and/or manipulated to enable data flow in the opposite direction.

The PHY 212 may further include one or more control signals through which one or more operation modes, functionalities and/or services of the PHY 212 may be configured and/or operated, for example, via one or more configuration keys, buttons and/or switches of the receive-only network device 202 described herein after. Optionally, the one or more of the control signals may be driven from the hardware programmable logic circuit 216 according to settings defined by the configuration keys, buttons and/or switches of the receive-only network device 202. For example, the hardware programmable logic circuit 216, may drive, set and/or configure one or more control signals of the PHY 212 to instruct the PHY 212 to conduct Time-Domain Reflection (TDR) testing and/or Optical Time-Domain Reflection (OTDR) for testing integrity of the hardware infrastructure and/or transmission medium(s) of the network 204 according to reflections of pulse signals transmitted by the PHY to the network 204, i.e., signals originating from the PHY 212. It should be noted that no frames may be initiated by manipulating the control signals, rather, as known in the art, while operated in the test mode, the PHY 212 may transmit only pulse signals which carry no data.

The hardware programmable logic circuit 216 may be implemented using one or more hardware elements, for example, a circuit, a component, a programmable device such as, for example, a Field Programmable Gate Array (FPGA) and/or the like which may not be hacked and/or tampered to operate in operation modes deviating from its intended and designated operation modes. For example, the hardware programmable logic circuit 216 may be implemented using one or more programmable FPGAs applying one or more measures as known in the art to prevent altering their internal logic after programmed.

The hardware programmable logic circuit 216 may be applied for one or more purposes and/or functionalities. For example, the hardware programmable logic circuit 216 may serve as a second unidirectional hardware buffer for the receive channel of the PHY 212 such that the receive channel may go through two unidirectional hardware buffers, namely the unidirectional hardware buffer 214 and the hardware programmable logic circuit 216 before connected to the local network controller 218.

To support this, the receive channel coming in from unidirectional hardware buffer 214 may be connected to one or more ports and/or pins of the hardware programmable logic circuit 216 which are configured (e.g. programmed) to have a single direction, for example, input only or output only according to their connection. For example, each signal of the receive channel coming from the PHY 212 may be connected to a port of the hardware programmable logic circuit 216 which is configured as input only thus incapable of outputting signals. In another example, each signal of the receive channel going to the local network controller 218 may be connected to a port of the hardware programmable logic circuit 216 which is configured as output only thus incapable of receiving signals.

Optionally, all signal lines (traces) connecting the hardware programmable logic circuit 216 to the local network controller 218 which route the receive channel originating from the PHY 212 to the local network controller 218, are routed via an unmodifiable unidirectional hardware buffer 217 such as the unidirectional hardware buffer 214. The unidirectional hardware buffer 217 may enable transfer of (data) signals in only one direction, specifically from the hardware programmable logic circuit 216 to the local network controller 218 while physically blocking signals coming in from the local network controller 218. This may prevent transferring data from the local network controller 218 to the hardware programmable logic circuit 216 in attempt to alter operation of the receive-only network device 202 in case the local network controller 218 and the hardware programmable logic circuit 216 are compromised and hacked.

The hardware programmable logic circuit 216 may be further used to control one or more of the control signal(s) of the PHY 212. For example, the hardware programmable logic circuit 216 may configure the PHY 212 to disable auto-negotiation of a network speed with a network controller 208 to which the receive-only network device 202 is connected. In another example, the hardware programmable logic circuit 216 may configure and/or operate the PHY 212 to conduct TDR and/or OTDR over the hardware infrastructure and/or transmission medium(s) of the network 204.

The controller 220 may include one or more processing nodes, cores and/or units optionally arranged for parallel processing, as clusters and/or as one or more multi core processor(s). The storage 222 may include one or more non-transitory persistent storage devices, for example, a Read Only Memory (ROM), a Flash array, and/or the like as well as one or more volatile storage devices, for example, a Random Access Memory (RAM) component, a cache and/or the like.

The controller 220 may execute one or more software modules such as, for example, a process, a script, an application, an agent, a utility, a tool, an Operating System (OS) and/or the like each comprising a plurality of program instructions stored in a non-transitory medium (program store) such as the storage 222 and executed by one or more controllers such as the controller 220. For example, the controller 220 may execute one or more software modules to execute the process 100. Moreover, the controller 220 may further include and/or utilize one or more hardware elements, for example, a circuit, a component, and IC, an ASIC and/or the like to execute the process 100 such that the process 100 may be executed using one or more software modules, one or more hardware modules or a combination thereof.

The receive-only network device 202 may include a power supply 228 configured to generate one or more power rails, for example, 12Vdc, 5Vdc, 3.3Vdc, 2.5Vdc and/or the like for the electrical components of the receive-only network device 202. The power supply 228 may generate the required power rail(s) using one or more power sources. For example, the power supply 228 may include a power circuit adapted to receive power from a power grid, for example, 110Vac/60 Hz, 220Vac/50 Hz and/or the like and convert them to the required power rail(s). In another example, the power supply 228 may include a power circuit adapted to utilize one or more batteries installed in the receive-only network device 202 to generate the required power rail(s). The power supply 228 may further include a charging circuit for recharging the batteries from the power grid.

Optionally, the power supply 228 may include a power circuit configured to receive power from the network 204 itself and adjust, relay and/or convert it to provide the required power rail(s). For example, assuming the network 204, specifically, the network controller 208 to which the receive-only network device 202 is connected supports power over the network, for example, Power over Ethernet (POE). In such case the power supply 228 may connect to one or more pins, connections and/or ports of the network connector(s) 210, for example, the RJ45 jack to receive power from the network 204. Optionally, in case the receive-only network device 202 includes one or batteries, specifically rechargeable batteries, the power supply 228 may include a charging circuit for recharging the batteries using the PoE.

The receive-only network device 202 may include a screen 224 for presenting visual data to a user, specifically data relating to the network 204. The receive-only network device 202 may optionally include a user interface 236 for interacting with the user. The user interface 236 may include, for example, one or more buttons to initiate one or more operations of receive-only network device 202, for example, an ON/OFF button, a reset button, an update button and/or the like. In another example, the user interface 236 may include one or more configuration keys, switches and/or the like to enable selection and/or configuration of one or more operation modes of the receive-only network device 202. The user interface 226 may further include more advanced Human-Machine Interfaces (HMI), for example, a keyboard, a pointing device (e.g. track ball, touch pad, touch screen, etc.) to enable higher level interaction with the user.

As shown at 102, the process 100 starts with the PHY 212 establishing a physical connection with the network 204, specifically with one of the network controller(s) 208 of the network 204. The PHY 212 may establish the physical connection according to the physical layer applicable for the network 204, for example, copper wires, optical fibers and/or the like.

As known in the art and described herein before, the physical layer may define the means of transmitting a stream of raw bits over a physical data link connecting the receive-only network device 202 to the network controller 208. The bitstream may be grouped into code words or symbols and converted to a physical signal that is transmitted over the wired transmission medium of the network 204, for example, copper wires and/or optical fibers. The physical layer may therefore define the electrical, mechanical, and procedural interfaces to the transmission medium, the frequencies to broadcast on, the line code to use and similar low-level parameters, and/or the like.

Optionally, the PHY 212 may be configured to disable an auto-negotiation sequence typically initiated with the network controller 208 via the wired transmission medium. The auto-negotiation sequence, as known in the art, is a signaling mechanism and procedure defined by the physical layer applicable to the wired transmission mediums used in network 204, which is initiated between two network nodes when first connected in order to establish common transmission parameters, such as for example, speed, duplex mode, flow control and/or the like.

However, the auto-negotiation sequence may be disabled and bypassed by one or both of the connected network nodes which may transmit only Normal Link Pulses (NLP) and avoid transmission of auto-negotiation pulses. In such case, as defined by the physical layer protocol, the physical connection between the two network nodes via the transmission medium may drop to the basic transmission parameters, for example, half-duplex 10Base-T.

The PHY 212 may be therefore configured to disable the auto-negotiation sequence when the receive-only network device 202 is connected to network 204 and apply half-duplex 10Base-T transmission via the wired transmission medium connecting to the network controller 208. Configuring the PHY 212 may be configured to disable the auto-negotiation for example, via its control signal(s). The control signal(s) of the PHY 212 may be connected to one or more switches and/or buttons available in the user interface 226 which may be set by one or more users. In another example, prolonged press (e.g. more than 5 seconds) on a certain button may switch the auto-negotiation operation mode from ON to OFF or from OFF to ON. Optionally, the user interface 226 includes one or more indicators, for example, a Light Emitting Diode (LED) indicating the operation mode (ON/OFF) of the auto-negotiation function.

As evident no connection is established between the PHY 212 and the network 204, specifically between the 212 and the network controller 208 meaning that no data is ever injected by the receive-only network device 202 to the network since no frames are ever transmitted by the receive-only network device 202 via the PHY 212 to the network 204.

As shown at 104, the PHY 212 may intercept one or more frames transmitted via the network 204 by one or more of the network nodes 206 and/or network controllers 208. The PHY 212 may transmit one or more of the received (intercepted) frames to the local network controller 218 which in turn may transmit the received frame(s) to the controller 220.

The intercepted frames may include frames defined by one or more protocols residing in one or more of the network model layers used over the underlying physical connection layer (L1), for example, data link layer (L2), network layer (L3), transport layer (L4), session layer (L5), presentation layer (L6) and/or application layer (L7).

As shown at 106, the controller 220 may analyze each received frame and identify and/or determine one or more parameters of the frame, for example, a type, a protocol, an applicability, a use and/or the like and/or the like based on the structure, fields, field(s) value, payload and/or the like of the frame as known in the art.

For example, based on analysis of the received frame, the controller 220 may identify the frame is a link layer frame defined by one or more link layer protocols, for example, a Station and Media Access Control Connectivity Discovery protocol according to IEEE 802.1AB with additional support in IEEE 802.3 section 6 clause 79, for example, LLDP, CDP, Foundry Discovery Protocol, Nortel Discovery Protocol, Link Layer Topology Discovery, ARP, RARP, NDP and/or the like.

In another example, the controller 220 may identify, based on analysis of the received frame, that the frame is a network layer frame defined by one or more network layer (L3) protocols, for example, Internet Protocol (IP), Internet Protocol Security (IPsec) and/or the like. In another example, based on analysis of the received frame, the controller 220 may identify the frame is a network layer frame defined by one or more transport layer (L4) protocols, for example, Transmission Control Protocol (TCP), User Datagram Protocol (UDP), an Internet Protocol Security (IPsec) and/or the like.

In another example, the controller 220 may analyze one or more fields of the received frame and/or its payload to identify the applicability (application), use and/or the like of the received frame. For example, based on the payload content of the received frame, the controller 220 may identify that the frame is an update frame intended for updating one or more of data and/or code modules stored and used by the receive-only network device 202.

The update frames may include, for example, one or more network information update frames comprising an update to one or more network information records, for example, a file, a table, a list, a data structure and/or the like locally stored at the receive-only network device 202, for example, in the storage 222. The network information record(s) may comprise (log) network information relating to one or more networks such as the network 204.

The network information of each network 204 may include one or more (reference) attributes of the respective network 204, for example, a type of the network controller(s) 208 of the network, a name of the network controller(s) 208, a MAC address of the network controller(s) 208, an IP address of the network controller(s) 208, a management port of the network controller(s) 208, a port number of the network controller(s) 208 connected to the receive-only network device 202, POE capability, Network Time Protocol (NTP) capability, hierarchy (level) of the network controller(s), structure of the network, an IP address range of one or more segments of the network, a network name, a network alias, a network symbol, a domain name of the network, one or more VLAN domains in the network, one or more CDP parameters announced by the network controller(s) 208 and/or the like.

In another example, the update frames may include one or more User Interface update frames comprising an update to one or more UI configuration records, for example, a file, a table, a list, a data structure and/or the like locally stored at the receive-only network device 202, for example, in the storage 222. The UI configuration record(s) may comprise and/or define one or more UI rules which may express which data may be presented to the user via the screen 224, a format of the presented data and/or the like.

In another example, the update frames may include one or more Code Version Update (CVU) frames comprising an update to one or more code segments (e.g. software, firmware, etc.) stored at the receive-only network device 202, for example, in the storage 222 and executed by the controller 220, specifically for executing the process 100.

As shown at 108, which is a conditional step, the process 100 may branch to 110 in case the received frame(s) is a link layer frame as defined by one or more of the link layer protocols. In case the frame(s) is an update frame, for example, a network information update frame, a UI update frame and/or a CVU frame, the process 100 may branch to 118.

As shown at 110, the controller 220 may analyze the received frame(s) in attempt to extract one or more of the network attributes of the network 204 which may be defined, expressed and/or derived from data and/or values of one or more fields and/or payload of the frame.

While the link layer frames may include data which may be highly indicative of the network attributes of the network 204 and thus highly useful for analysis by the controller 220, one or more of the network attributes of the network 204 may be also and/or further extracted from one or more higher layer frames, for example, a network layer frame, a transport layer frame, an application layer frame and/or the like. Therefore, in addition to link layer frames, the process 100 may optionally branch to 110 also in case the controller 220 determines that the received frame(s) is a higher layer frame.

As shown at 112, the controller 220 may identify the network 204 at least partially according to the network attributes extracted from the received frame(s). For example, the controller 220 may identify the network name of the network 204. In another example, the controller 220 may identify the IP address range of the network 204. In another example, the controller 220 may identify the topology and hierarchy of the network 204. In another example, the controller 220 may identify the IP address and/or name of one or more network controllers 208 of the network 204. In another example, the controller 220 may identify the IP address and/or name of one or more neighboring network nodes 206 connected to the network 204.

As shown at 114, which is an optional step, the controller 220 may compare between one or more of the network attributes of the network 204 extracted from the received frame(s) and corresponding reference network attributes of the network 204 as logged in the network information record(s).

For example, assuming the controller 220 identifies the network 204 based on its network name extracted from one or more received frames and further identifies the IP address range of the network 204 based on one or more of the received frames. In such case, the controller 220 may access the network information record(s) and use the network name of the network 204 to fetch the IP address range logged in the network information record(s) for the network 204. In such case, the controller 220 may compare between the extracted IP address range and the logged IP address range.

In another example, assuming the controller 220 identifies the network 204 based on a name of a certain network controller 208 of the network 204 extracted from one or more received frames. Further assuming the controller(s) identifies the IP address of the certain network controller 208 based on one or more of the received frames. In such case, the controller 220 may access the network information relating to the network 204 in the network information record(s) and fetch the name and the IP address logged in the network information record(s) for the certain network controller 208. The controller 220 may further compare between the extracted name and IP address of the certain network controller 208 and the logged name and IP address of the certain network controller 208.

As shown at 116, the controller 220 may operate the screen 224 to present the network identity to the user, specifically identification data of the network 204, for example, one or more of the network attributes of the network 204 extracted from the received and analyzed frame(s).

Optionally, the controller 220 may operate the screen 224 to present additional network information for the network 204 to the user in case of a match between one or more of the network attribute extracted from the received frame(s) and the corresponding reference network attribute(s) logged in the network information record(s). For example, assuming the controller 220 identifies the network name of the network 204 based on network attribute(s) extracted from one or more received frame(s). The controller 220, using the network name, may fetch one or more additional network attributes of the network name 204 logged in the network information record(s), for example, a network hierarchy, an NTP, one or more VLAN domains and/or the like. In such case, the controller 220 may operate the screen 224 to present the additional network attribute(s) retrieved from the network information record(s).

Optionally, the controller 220 may operate the screen 224 to present to the user the network identification data of the network 204 according to one or more rules defined in the UI configuration record(s). For example, a certain UI rule may define that only certain network attributes of the network 204 should be displayed on the screen 224. For example, a certain UI rule may define that only certain network attributes of the network 204 should be displayed on the screen 224. In another example, a certain UI rule may define a specific format for displaying the network attributes of the network 204 on the screen 224. In another example, a certain UI rule may define that only network attributes extracted from received frames should be presented on the screen 224 with no additional obtained from the network information record(s).

The controller 220 may be further configured to output one or more indications to indicate and/or alert the user of one or more events, conditions and/or settings detected in the network 204.

For example, the controller 220 may output one or more discrepancy indications in case it detects a no-match between one or more of the network attribute of the network 204 extracted from the received frame(s) and one or more corresponding reference network attributes logged in the network information record(s). For example, assuming the controller 220 detects a certain number of computing nodes 206 connected to the network 204. Further assuming that based on the network information logged for the network 204 in the network information record(s) there is a different number of computing nodes 206 connected to the network. In such case, the controller 220 may output a discrepancy indication.

In another example, the controller 220 may output one or more approval indications in case it identifies a match between the network attribute of the network 204 extracted from the received frame(s) and the corresponding reference network attributes logged in the network information record(s).

The indications may be generated using one or more interfaces and/or modalities available at the receive-only network device 202. For example, the controller 220 may generate one or more visual indications by operating the screen 224 to present one or more messages. In another example, the controller 220 may operate one or more audio interfaces, for example, a speaker available in the user interface 226 to generate an audible indication.

Optionally, the hardware programmable logic circuit 216, may drive and/or configure one or more control signals of the PHY 212 according to settings of one or more of the buttons, configuration keys and/or switches of the user interface 226 to instruct the PHY 212 to conduct TDR testing and/or OTDR testing to test integrity of the hardware infrastructure and/or transmission medium(s) of the network 204 according to reflections of signals transmitted by the PHY to the network 204, i.e., signals originating from the PHY 212.

Optionally, the controller 220 may discard the network identification data and/or the network attributes of the network 204 after presented to the user via the screen 224, specifically, after the receive-only network device 202 is disconnected from the network 204 and/or after a predefined time afterwards.

As shown at 118, after determining that the received frame(s) is an update frame, the controller 220 may analyze the update frame(s) to determine whether the update frame is a network information update frame(s), a UI update frame(s) or a CVU frame(s).

The update frames intercepted by the PHY 212 of the receive-only network device 202 while connected to the network 204, specifically, the network information update frames, the UI update frames and the CVU frames may be typically transmitted by one or more dedicated servers connected to the network 204. The dedicated server may transmit one or more update frames which contain data of an update package that should be applied to one or more of the network information record(s), the UI configuration record(s) and/or the code (e.g. software, firmware, etc.) executed by the controller 220.

Typically, the update frame(s) may not be directed to any specific receive-only network device 202 but may rather include broadcast and/or multicast frames (packets) which may be intercepted and used by any receive-only network device 202 connected to the network 204. Moreover, the receive-only network device 202 may be connected to one or more specific networks such as the network 204, for example, a service network, a maintenance network and/or the like to which the dedicated server is connected. Therefore, while connected to the specific network(s) the receive-only network device 202 may receive the update frame(s) transmitted by the dedicated server.

The dedicated server may optionally sign one or more of the update frames with a unique signature in order to enable the receive-only network device 202 to verify that the update frames originate from the dedicated server. The dedicated server may apply one or more methods, algorithms and/or techniques to sign the update frames. For example, the dedicated server may sign the update frames with a signature based on a private-public cryptographic key pair. The private key associated with the dedicated server may be privately and securely available only to the dedicated server while the public key which is derived from the private key is publicly distributed and thus available to the receive-only network device 202.

As shown at 120 which is a conditional step, in case the update frame(s) is a network information update frame(s) the process 100 may branch to 122, in case the update frame(s) is a UI update frame(s) the process 100 may branch to 132 and in case the update frame(s) is a CVU frame(s) the process 100 may branch to 142.

As shown at 122, which is an optional step depending on whether the network information update frame(s) is signed or not, in case the network information update frame(s) is signed, the controller 220 may use the public key associated with the dedicated server to verify the signature of the network information update frame(s) and verify that the network information update frame(s) originates from the dedicated server.

As shown at 124, which is another conditional step, the controller 220 may check whether the received network information update frame(s) is the last update frame of the update package transmitted by the dedicated server. In case the received network information update frame(s) is the last update frame, the process may branch to 126. Otherwise the process 100 may branch back to 104 in order to intercept one or more additional network information update frame(s) of the update package.

As shown at 126, after receiving the complete network information update package, the controller 220 may update the network information record(s) according to the network information update package contained in the received network information update frame(s).

As shown at 132, which is an optional step depending on whether the UI update frame(s) is signed or not, in case the UI update frame(s) is signed, the controller 220 may use the public key associated with the dedicated server to verify the signature of the UI update frame(s) and verify that the UI update frame(s) originates from the dedicated server.

As shown at 134, which is a conditional step, the controller 220 may check whether the received UI frame(s) is the last update frame of the update package transmitted by the dedicated server. In case the received UI update frame(s) is the last update frame, the process may branch to 136. Otherwise the process 100 may branch back to 104 in order to intercept one or more additional UI update frame(s) of the update package.

As shown at 136, after receiving the complete UI update package, the controller 220 may update the network information record(s) according to the UI update package contained in the received UI update frame(s).

As shown at 142, which is an optional step depending on whether the CVU frame(s) is signed or not, in case the CVU frame(s) is signed, the controller 220 may use the public key associated with the dedicated server to verify the signature of the CVU frame(s) and verify that the CVU frame(s) originates from the dedicated server.

As shown at 144, which is a conditional step, the controller 220 may check whether the received CVU frame(s) is the last update frame of the update package transmitted by the dedicated server. In case the received CVU frame(s) is the last update frame, the process may branch to 146. Otherwise the process 100 may branch back to 104 in order to intercept one or more additional CVU frame(s) of the update package.

As shown at 146, after receiving the complete CVU package, the controller 220 may update the network information record(s) according to the CVU package contained in the received CVU frame(s).

Since the receive-only network device 202 is incapable of transmitting data frame(s) via the network 204, the receive-only network device 202 is unable to interact with the dedicated server. Therefore, in case one or more update frames are not received by the receive-only network device 202, since it is unable to request the dedicated server to re-send the missing frame(s), the receive-only network device 202 may terminate the current update session and discard all update frames received which were already received. The receive-only network device 202 may initiate the update process in case the dedicated server starts sending the update frames again starting from the first update frame.

Optionally, in one or more of the data structures and/or code segments of the receive-only network device 202 are updated using one or more local ports and/or interfaces of the receive-only network device 202, for example, a Universal Serial Bus (USB) port, a serial port, a proprietary communication port and/or the like.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems, methods and computer programs will be developed and the scope of the terms transmission mediums, PHY devices, link layer frames and link layer discovery protocols are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A receive-only network device for securely identifying a network, comprising:
a network physical layer (PHY) circuit configured to establish a physical layer connection to a network via at least one wired transmission medium;
a controller electrically coupled to a receive channel of the PHY via a unidirectional hardware buffer configured to transfer electronic signals received from the PHY and block electronic signals received from the controller, the controller is configured to:
receive from the PHY at least one link layer frame transmitted by at least one network controller of the network and intercepted by the PHY,
extract at least one network attribute of the network from the at least one intercepted link layer frame;
identify the network at least partially according to the at least one extracted network attribute; and
present the identity of the network to a user.

2. The receive-only network device of claim 1, wherein a transmit channel of the PHY is physically disconnected.

3. The receive-only network device of claim 1, further comprising a second hardware buffer connecting the receive channel of the PHY to the controller, the second hardware buffer is configured to transfer electronic signals received from the PHY and block electronic signals received from the controller.

4. The receive-only network device of claim 3, wherein the second hardware buffer comprises a hardware programmable logic circuit configured to have an input only port connected to the PHY and an output only port connected to the controller.

5. The receive-only network device of claim 4, further comprising another unidirectional hardware buffer configured to transfer electronic signals from the hardware programmable logic circuit to the controller and block signals received from the controller.

6. (canceled)

7. The receive-only network device of claim 1, wherein the PHY is further configured to disable auto-negotiation sequence via the at least one wired transmission medium and apply half-duplex 10Base-T using normal link pulses (NLP) protocol to connect to the network.

8. The receive-only network device of claim 1, wherein the link layer frame is defined by at least one station and media access control connectivity discovery protocol.

9. (canceled)

10. The receive-only network device of claim 1, wherein the controller is further configured to compare between the at least one extracted network attribute and a corresponding at least one reference network attribute logged in at least one network information record stored in the receive-only network device.

11. The receive-only network device of claim 10, wherein the controller is configured to output at least one selected from the group consisting of:
a discrepancy indication in case of no-match between the at least one extracted network attribute and the corresponding at least one reference network attribute;
an approval indication in case of a match between the at least one extracted network attribute and the corresponding at least one reference network attribute; and
additional network information for the network in case of a match between the at least one extracted network attribute and the corresponding at least one reference network attribute, the additional network information is stored in the at least one network information record.

12. (canceled)

13. (canceled)

14. The receive-only network device of claim 10, wherein the controller is further configured to update the at least one network information record according to at least one network information update frame transmitted by a dedicated server and intercepted by the PHY from the network.

15. The receive-only network device of claim 14, further comprising the at least one network information update frame is signed with a signature used by the controller to verify the at least one network information update frame.

16. The receive-only network device of claim 1, wherein the identity of the network is presented to a user via a screen of the receive-only network device.

17. The receive-only network device of claim 16, wherein the controller is further configured to present the network identity via the screen according to at least one user interface (UI) rule defined by a at least one UI configuration record stored in the receive-only network device.

18. The receive-only network device of claim 17, wherein the controller is further configured to update the at least one UI configuration record according to at least one UI update frame transmitted by a dedicated server and intercepted by the PHY from the network.

19. The receive-only network device of claim 18, further comprising the at least one UI update frame is signed with a signature used by the controller to verify the at least one UI update frame.

20. The receive-only network device of claim 1, wherein the controller is further configured to discard the at least one network attribute and the network identity extracted from the at least one intercepted link layer frame.

21. The receive-only network device of claim 1, wherein the controller is further configured to update code executed by the controller according to at least one code version update (CVU) frame transmitted by a dedicated server and intercepted by the PHY from the network.

22. The receive-only network device of claim 21, further comprising the at least one CVU frame is signed with a signature used by the controller to verify the at least one CVU frame.

23. The receive-only network device of claim 1, further comprising at least one hardware programmable logic circuit configured to electrically drive at least one input only control signal of the PHY in order to operate the PHY to conduct time-domain reflection (TDR) testing and/or optical time-domain reflection (OTDR) for testing integrity of a hardware infrastructure of the network according to reflections of signals transmitted by the PHY to the network.

24. A method of securely identifying a network using a receive-only network device, comprising:
using a controller of a receive-only network device comprising a network physical layer (PHY) circuit configured to establish a physical layer connection to a network via at least one wired transmission medium, the controller is used for:
receiving from the PHY at least one link layer frame transmitted by at least one network controller of the network and intercepted by the PHY,
extracting at least one network attribute of the network from the at least one intercepted link layer frame;
identifying the network at least partially according to the at least one extracted network attribute; and
presenting the identity of the network to a user;
wherein the controller is electrically coupled to a receive channel of the PHY via a unidirectional hardware buffer configured to transfer electronic signals received from the PHY and block electronic signals received from the controller.
